(19) United States
(12) Patent Application Publication
(10) Pub. No.: US 2009/0255244 A1
(43) Pub. Date: Oct. 15, 2009

(54) Continuous fluid circuit electricity generating system

(76) Inventor: Saeed Moflihi, Brooklyn, NY (US)

Correspondence Address: Morland C. Fischer, Suite 1300, 2030 Main Street, Irvine, CA, 92614, US

(21) Appl. No.: 12/082,636

(22) Filed: Apr. 14, 2008

(51) Int. Cl. F03B 1/04

(52) U.S. Cl. 60/327; 60/222

(57) ABSTRACT

A continuous fluid circuit electricity generating system for producing relatively expensive electricity without polluting the atmosphere or consuming natural resources. A first turbine submerged in a source of water (e.g., a man-made tank or a naturally-occurring well or larger body of water) supplies water under pressure from the source to a water propulsion turbine. The water propulsion turbine has a rotatable shaft coupled to the shaft of a first generator of electricity and a set of hollow impeller arms coupled to and rotatable with the turbine shaft. The impeller arms of the water propulsion turbine are located in proximity to a rotatable driven rotor having a coupling sleeve surrounding the shaft of a second generator of electricity. Water moving through and expulsed from the hollow impeller arms causes the impeller arms, the shaft of the water propulsion turbine, and the shaft of the first generator to rotate in a first direction. The water expulsed from the hollow impeller arms strikes impact surfaces of the rotatable driven rotor to cause the driven rotor, the coupling sleeve of the driven rotor, and the shaft of the second generator to rotate in an opposite direction. The water which has been ejected from the impeller arms is then returned to the source for reuse.

### BACKGROUND OF THE INVENTION

1. Field of the Invention

This invention relates to a continuous fluid circuit electricity generating system including a water propulsion turbine to which water under pressure is supplied from a submerged high-speed turbine. The water propulsion turbine ejects the water from hollow impeller arms thereof to impart opposite rotations to the respective shafts of a pair of generators which produce electricity for purposes of storage or consumption.

2. Background Art

As populations grow, there is an ongoing need for means to generate electricity without wasting valuable natural resources or polluting the atmosphere. In some cases, coal and oil reserves have been depleted to enable utilities to have the energy needed to produce relatively inexpensive electricity. In other cases, the atmosphere has been polluted by power generators which is a contributing factor to global warming. To this end, wind and solar energy have already been used to generate electricity. However, the availability of sufficient wind and sunlight on a continuous basis is limited in certain locations. The cost and inherent risk associated with nuclear power plants have made this form of power unsuitable in a majority of the world's countries.

With inhabitants of third world and developing countries expanding to rural or remote locations, the ability to inexpensively produce electricity to support and promote such growth and expansion is vital. Accordingly, what continues to be desirable is an efficient, clean and reusable system for generating electricity for use by both large utility companies and small rural power stations so as to better promote and sustain world growth and prosperity.

### SUMMARY OF THE INVENTION

In general terms, an efficient continuous fluid circuit electricity generating system is disclosed which consumes few natural resources, does not pollute the atmosphere, and is relatively inexpensive to operate. A high-speed turbine is submerged in a man-made water supply, such as a subsurface tank filled with water or a natural water supply, such as an artesian well or a larger body of water. Water from an above-ground reservoir is pumped below ground through a fluid intake pipe to the submerged turbine. Water ejected under pressure from the water intake pipe causes a set of turbine blades to rotate at high speed to push water from the subsurface supply upwardly through a water outlet pipe and back to the above-ground reservoir. The reservoir water is then pumped to a water intake of an above-ground water propulsion turbine. Water flows from the water intake through a plurality of hollow arcuate-shaped driving impeller arms of the water propulsion turbine.

The hollow driving impeller arms are coupled to the shaft of the water propulsion turbine. The shaft of the water propulsion turbine is coupled to the shaft of a first generator of electricity. Water being ejected under pressure from the arcuate driving impeller arms causes the arms to rotate in a first direction. A rotation of the arms correspondingly causes the rotor shaft as well as the shaft of the first generator coupled to the rotor shaft to also rotate in the first direction.

The driving impeller arms of the water propulsion turbine are disposed in close proximity to water impact surfaces which project inwardly from an outer rim of a driven rotor. The driven rotor has a coupling sleeve which is located at the center of the outer rim to surround and engage the shaft of a second generator of electricity. The water ejected under pressure from the driving impeller arms strikes the water impact surfaces carried by the outer rim of the driven rotor to cause the driven rotor and the shaft of the second generator coupled to the driven rotor at the coupling sleeve thereof to rotate in a second direction which is opposite the first direction of rotation of the driving impeller arms and the shaft of the first generator. Water ejected from the impeller arms for rotating the driven rotor is returned to the subsurface water supply via a drain. The electricity produced by the first and second generators is carried by wires for either consumption or storage as needed.

### BRIEF DESCRIPTION OF THE DRAWINGS

FIG. 1 is illustrative of a continuous fluid circuit electricity generating system according to a preferred embodiment of the present invention;

FIG. 2 illustrates details of a submerged, subsurface high-speed turbine from the electricity generating system of FIG. 1;

FIG. 3 illustrates details of an above-ground water propulsion turbine of the electricity generating system of FIG. 1 which lies in fluid communication with the submerged turbine of FIG. 2;

FIG. 4 shows the interaction of driving impeller arms of the water propulsion turbine of FIG. 3 with a driven rotor;

FIG. 5 shows details of the driving impeller arms of the water propulsion turbine coupled to the shaft of a first generator of electricity; and

FIG. 6 shows details of the driven rotor coupled to the shaft of a second generator of electricity.

### DESCRIPTION OF THE PREFERRED EMBODIMENT

Referring initially to FIG. 1 of the drawings, there is shown a preferred embodiment for a continuous fluid circuit electricity generating system 1 which forms the present invention. The electricity generating system 1 herein disclosed is ideal for use by both large, urban utility companies and by small, rural power stations, or wherever an efficient, non-polluting means of generating electricity is required. However, as will be explained hereinafter, an available source of water is required to provide the driving force to power generators for producing electricity.

In this regard, the electricity generating system 1 communicates with a primary supply of water 3. The primary water supply 3 is preferably located below ground. Water supply 3 may be enclosed by a man-made (e.g., 5,000 gallon) underground tank. In the alternative, the water supply 3 may be a naturally-occurring water reservoir, such as an artesian well, a larger body of water, or the like.

A first high-speed, high-pressure (e.g., 10 to 20 horsepower) pump 5 is located at the input side of the power generating system. The pump 5 is connected between a small above-ground reservoir 12 and a subsurface (i.e., below ground level) high-speed turbine 7 by way of a relatively long and narrow (e.g., 2 inches in diameter) fluid intake pipe 8. The reservoir 12 is initially partially or completely filled with water. The turbine 7 is submerged within the primary water supply 3. Ideally, the fluid intake pipe 8 has a length of 350 to 500 feet above water supply 3. The fluid intake pipe 8 extends for approximately another 30 feet to the submerged turbine 7 if the primary water supply 3 is a tank or approximately another 600 feet if the primary water supply is a natural well or a body of water. In this manner, the force of gravity to which the input water is subjected will minimize the pumping requirements of pump 5 to deliver water under pressure from reservoir 12 to the turbine 7 through fluid intake pipe 8.

The relatively narrow fluid intake pipe 8 is surrounded by a relatively wide (e.g., 10 inches in diameter) fluid outlet pipe 10. Fluid outlet pipe 10 is coaxially aligned with and surrounds the fluid intake pipe 8. The fluid outlet pipe 10 extends from the submerged, high-speed turbine 7 within water supply 3 to the above-ground reservoir 12.

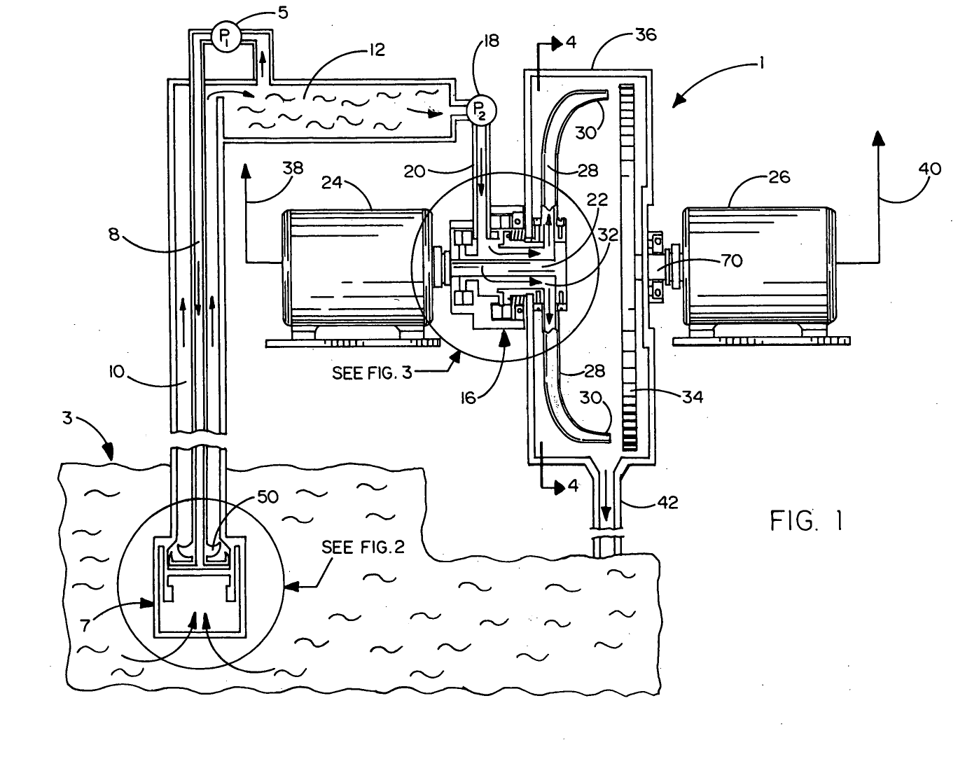

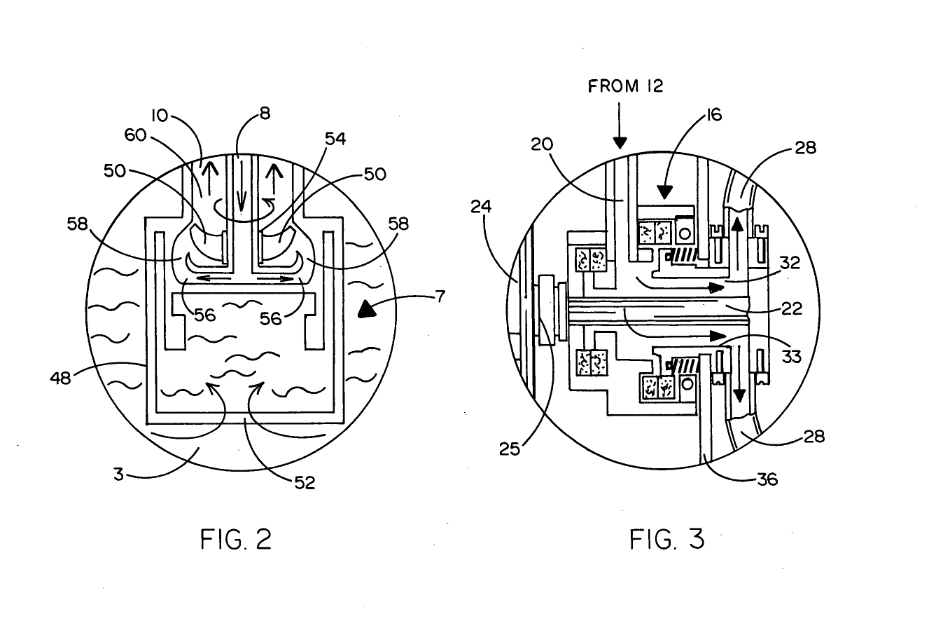

As will be disclosed in greater detail while referring to FIG. 2, the combination of pump 5 and gravity force water under pressure (at approximately 150 psi) downwardly through fluid intake pipe 8 to the high-speed turbine 7. The water exiting pipe 8 is directed against a set of blades (designated 50 in FIG. 2) of submerged turbine 7 to cause the blades to rotate at high speed (e.g., 42,000 rpm). The high speed rotation of the turbine blades 50 pushes water from water supply 3 upwardly through the fluid outlet pipe 10 and into the above-ground reservoir 12 so that the reservoir will always have a supply of water therewithin.

Reservoir 12 communicates with an above-ground high-speed water propulsion turbine 16 located at the output side of the system 1 by way of a second (e.g., 10 to 20 horsepower) pump 18. The second pump 18 pumps water from reservoir 12 into the water propulsion turbine 16 via a water intake 20 thereof. Whenever the reservoir 12 is completely filled with water carried by pipe 10 from the submerged turbine 7 and the electricity generating system 1 is fully pressurized, the operation of the second pump 18 may be suspended.

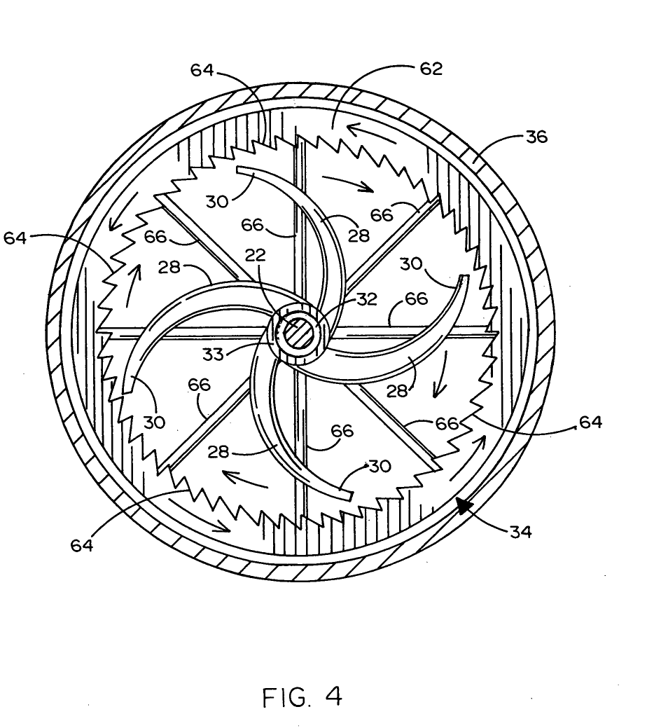

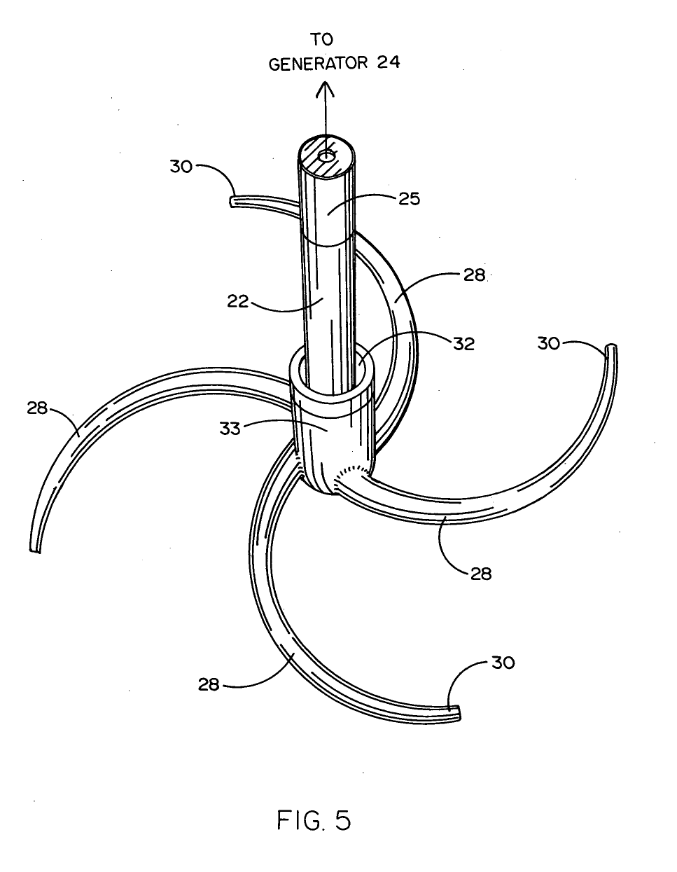

As will be explained in greater detail while referring to FIG. 3, the water propulsion turbine 16 includes a shaft 22. One end of the turbine shaft 22 is coupled to the shaft (25 in FIG. 5) of a first electrical generator 24. The opposite end of shaft 22 is coupled to a plurality of (e.g., four) hollow driving impeller arms 28 (best shown in FIG. 4). In the alternative, the impeller arms 28 may have outer shells with water carrying conduits running therethrough. Each of the hollow impeller arms 28 has an arcuate shape which gradually tapers in width toward a relatively narrow nozzle end or jet 30. The hollow interiors of impeller arms 28 are coupled in fluid communication with the water intake 20 of water propulsion turbine 16 by way of a water passage 32 that runs longitudinally through turbine 16 around the turbine shaft 22.

As is also best shown in FIG. 4, the nozzle ends 30 of the driving impeller arms 28 are aligned opposite water impact surfaces 64 of a driven rotor 34. As will be explained in greater detail while referring to FIGS. 4-6, the water ejected from the nozzle ends 30 of the driving impeller arms 28 of water propulsion turbine 16 cause the arms 28 and the turbine shaft 22 to which the arms are coupled to rotate (e.g., at 42,000 rpm) in a first (e.g., clockwise) direction. At the same time, the driven rotor 34, having impact surfaces 64 against which the water ejected from the nozzle ends 30 of driving impeller arms 28 is directed, will rotate in an opposite (e.g., counterclockwise) direction. Each of the driving impeller arms 28 of water propulsion turbine 16 and the driven rotor 34 are enclosed by a (e.g., stainless steel) casing 36 to prevent the ambient wind from possibly interfering with the rotation of impeller arms 28.

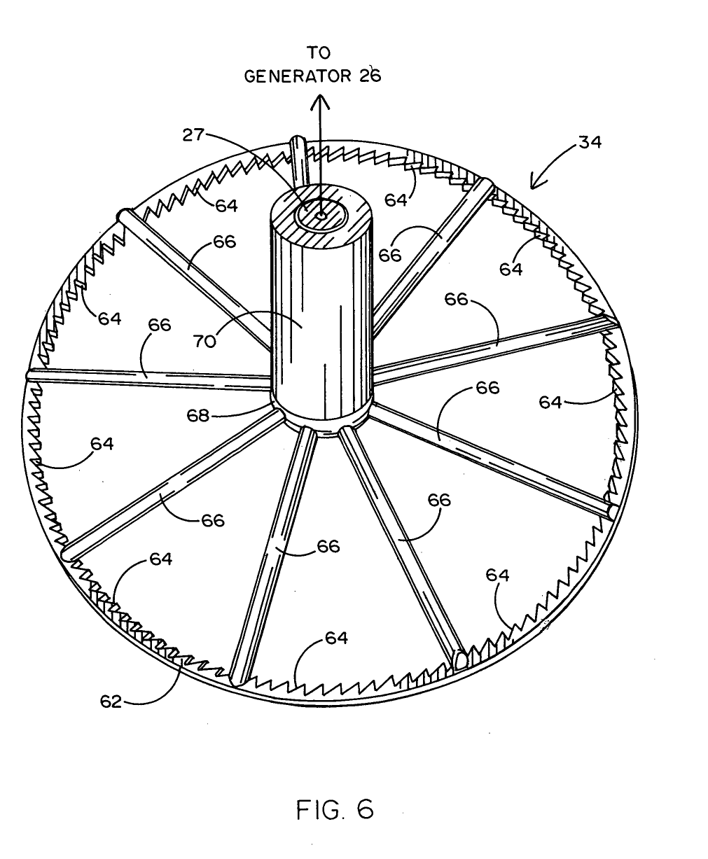

The driven rotor 34 is coupled to the shaft (27 in FIG. 6) of a second electrical generator 26. Thus, a rotation of the driven rotor 34 caused by the water ejected from the nozzle ends 30 of the driving impeller arms 28 of water propulsion turbine 16 is imparted to the shaft 27 of the second generator 26. Hence, it may be appreciated that the shafts 25 and 27 of generators 24 and 26 are rotated in opposite directions relative to one another by the driving impeller arms 28 and the driven rotor 34, respectively. The output electricity produced by generators 24 and 26 is carried by wires 38 and 40 for storage or consumption on an as-needed basis.

The casing 36 surrounding the rotating hollow driving impeller arms 28 of water propulsion turbine 16 and the counter-rotating driven rotor 34 is located above the primary water supply 3. The interior of casing 36 communicates with the water supply via a drain 42. In this case, the water ejected from the nozzle ends 30 of impeller arms 28 which strikes the impact surfaces 64 and rotates the driven rotor 34 is automatically returned, under the influence of gravity, to water supply 3 to be recycled around the electricity generating system 1 by way of fluid intake and fluid outlet pipes 8 and 10. By virtue of the foregoing, the electricity generating system 1 and the primary subsurface water supply 3 communicating therewith complete an efficient, continuous loop around which water is conveyed.

Referring now to FIG. 2 of the drawings, details are provided of the subsurface high-speed turbine 7 that is submerged in the water supply 3 above which the fluid pump 5, reservoir 12, first and second generators 24 and 26, and the water propulsion turbine 16 are located. As previously explained, water is forced, by pump 5 and gravity from the above-ground reservoir 12 downwardly to the submerged, subsurface turbine 7 via fluid intake pipe 8. The submerged turbine 7 includes an outer housing 48 having a screen 52 or similar perforations to admit water from the water supply 3. Located inside housing 48 is the set of blades 50 that are carried by a cylindrical collar 54. A total of eight blades 50 is preferable to project from the collar 54 as either a single set (as shown) or as two sets of four blades each located one behind the other. The collar 54 surrounds the lower end of the fluid intake pipe 8 so as to be rotatable therearound. The blades 50 are connected to collar 54 so as to create angled impact faces.

Water pumped down the fluid intake pipe 8 is forced through radial distribution channels 56 of the submerged turbine 7. The water is ejected under pressure from upturned nozzles 58 at the ends of the water distribution channels 56 so as to strike the angled impact faces of turbine blades 50 which lie adjacent nozzles 58. The water streams or jets exiting the nozzle ends 58 of channels 56 create a driving force against the angled faces of turbine blades 50 to cause the blades and the collar 54 to which the blades are connected to rotate at high speed as indicated by the reference arrow 60. The rotating turbine blades 50 create a corresponding force that draws water from housing 48 and pushes the water upwardly through the fluid outlet pipe 10 towards reservoir 12.

Turning to FIG. 3 of the drawings, a description is provided of the above-ground water propulsion turbine 16 which is coupled to and controls the operation of each of the electricity generators 24 and 26. As previously explained, water is pumped by pump 18 from reservoir 12 to turbine 16 through water intake 20. The water propulsion turbine 16 herein disclosed may be identical with the turbine described in my earlier U.S. Pat. No. 7,306,045 entitled “MULTI-STAGE FLUID POWER TURBINE FOR A FIRE EXTINGUISHER” issued Dec. 11, 2007, the teachings of which are incorporated herein by reference. Therefore, for purposes of efficiency, only a brief description of turbine 16 will be given.

Incoming water from the water intake 20 is forced under pressure through the longitudinally-extending water passage 32 that runs between the turbine shaft 22 and a bearing housing 33 (best shown in FIG. 5). Water passage 32 lies in fluid communication with each of the hollow driving impeller arms 28 of turbine 16. Each impeller arm 28 is preferably three meters in length. Water rushing through the driving impeller arms 28 is directed against the driven rotor (designated 34 in FIG. 4) to cause generators 24 and 26 to generate electricity in a manner that will now be disclosed.

FIGS. 4-6 of the drawings describe the interaction between the hollow driving impeller arms 28 of the water propulsion turbine 16 (of FIG. 3) and the driven rotor 34 that are enclosed by the wind-tight casing 36 to cause the shafts 25 and 27 of electricity generators 24 and 26 to rotate in opposite directions. A total of four arcuate impeller arms 28 are shown connected to and bending away from the bearing housing 33 of turbine 36. Although four impeller arms 28 are shown, a different number of impeller arms may also be used depending upon the size and weight of the driven rotor 34. Because the arcuate impeller arms 28 in the example of FIGS. 4 and 5 bend in a counterclockwise direction, the water ejected from the nozzle ends 30 of impeller arms 28 will cause the arms 28, the turbine shaft 22, and the shaft of generator 24 coupled to turbine shaft 22 to all rotate together in a clockwise direction.

According to the preferred embodiment, the driven rotor 34 (best shown in FIG. 6) is a stainless steel wheel-like structure having a circular outer rim 62 with a set of short angled, saw-tooth shaped impact surfaces 64 projecting inwardly from rim 62. The rim 62 of driven rotor 34 has a circumference capable of surrounding the driving impeller arms 28, whereby the nozzle ends 30 of arms 28 lie opposite and in close proximity to the impact surfaces 64 (best shown in FIG. 4).

A set of (e.g., eight) spokes or braces 66 are connected (e.g., welded) between the outer rim 62 of driving rotor 34 and an inner central hub 68. The spokes 66 maintain the structural integrity of and support the outer rim 62 of driven rotor 34 during high speed rotation. A cylindrical coupling sleeve 70 is connected through casing 36 to the central hub 68 so as to lie in coaxial alignment with the outer rim 62 of driven rotor 34. Coupling sleeve 70 surrounds and is coupled to the shaft 27 of the generator 26, such that a rotation of the driven rotor 34 will be imparted to the generator shaft 27 at coupling sleeve 70.

As previously described, the water under pressure being ejected from the nozzle ends 30 of the driving impeller arms 28 of the water propulsion turbine 16 strikes the adjacently-disposed angled impact surfaces 64 along the outer rim 62 of driven rotor 34. The jet action of the water exiting nozzle ends 30 and striking successive impact surfaces 64 causes rotor 34 to spin or rotate. As was also described, because the driving impeller arms 28 and the shaft 22 of the water propulsion turbine rotate in a clockwise direction, the driven rotor 34 and the shaft 27 of generator 26 coupled to driven rotor 34 will rotate together in an opposite, counter-clockwise direction.

It may be appreciated that the water being supplied to the water propulsion turbine 16 by the submerged turbine 7 is returned to the primary water supply 3 as part of a continuous fluid circuit system for generating electricity relatively inexpensively where little natural resources are wasted and the atmosphere is not polluted. In this regard, additional pairs of the submerged and the water propulsion turbines 7 and 16 connected in fluid communication with one another in the manner described above may be used in combination with additional pairs of first and second generators 24 and 26 to increase the total production of electricity. What is more, because it is relatively plentiful and generally inexpensive, water has been disclosed as the fluid moving around the continuous fluid circuit system of this invention. Although water is preferred, it is to be understood that other fluids, including liquids and gases, could also circulate through the system in place of water for powering turbines 7 and 16.

1. A system to generate electricity, comprising:
a source of fluid;
at least a first generator to produce the electricity having a rotatable shaft;
a first fluid propulsion station receiving fluid from said source thereof; and
a second fluid propulsion station located in fluid communication with said first fluid propulsion station and having a rotatable shaft coupled to the shaft of said first generator and a set of fluid transmitting arms coupled to and rotatable with the shaft of said second fluid propulsion station,
said first fluid propulsion station supplying the fluid received from said source of fluid to said second fluid propulsion station and through said set of fluid transmitting arms thereof, such that the fluid exiting said fluid transmitting arms generates a force for causing each of the shaft of said second fluid propulsion station and the shaft of said first generator coupled thereto to rotate in a first direction.

2. The system recited in claim 1, wherein the fluid of said source of fluid is water, and the fluid transmitting arms of said second fluid propulsion station are water transmitting arms.

3. The system recited in claim 2, wherein said source of water is located below ground.

4. The system recited in claim 2, wherein said first fluid propulsion station is a first turbine submerged within said source of water, said submerged first turbine receiving water from said source thereof and supplying said water to said second fluid propulsion station.

5. The system recited in claim 4, wherein said second fluid propulsion station is a driving second turbine located above said source of water and having a water intake communicating with said submerged first turbine to receive the water supplied by said first turbine and deliver said water to the water transmitting arms of said second turbine.

6. The system recited in claim 5, wherein said submerged first turbine has a set of rotatable turbine blades, said first turbine receiving water from said source thereof, and said turbine blades rotating to cause said water to be supplied to the water intake of said driving second turbine.

7. The system recited in claim 6, further comprising a water input pipe and a water output pipe each communicating with said submerged first turbine, a pump connected to said water input pipe, and a reservoir in which water is stored, said reservoir located above said source of water and connected between the water intake of said driving second turbine and each of said pump and said water output pipe, said pump pumping water from said reservoir to said submerged first turbine by way of said water input pipe to cause said turbine blades to rotate, and said rotating turbine blades causing the water received from said source to be supplied to the water intake of said driving second turbine by way of said water output pipe and said reservoir.

8. The system recited in claim 7, wherein said water output pipe surrounds said water input pipe and the rotatable blades of said submerged first turbine project from a collar located within said source of water, said collar surrounding said water input pipe inside said water output pipe and rotating around said water input pipe in response to the water being pumped by said pump to said submerged first turbine by way of said water input pipe.

9. The system recited in claim 5, further comprising:
a rotatable driven rotor located in proximity to the water transmitting arms of said driving second rotor; and
a second generator to produce the electricity having a rotatable shaft coupled to and rotatable with the rotatable driven rotor,
wherein the water exiting the water transmitting arms of said driving second turbine is directed against said rotatable driven rotor to cause each of said driven rotor and the shaft of said second generator to rotate in a second direction which is opposite the first direction of rotation of the respective shafts of said driving second turbine and said first generator.

10. The system recited in claim 9, wherein said rotatable driven rotor has a coupling sleeve surrounding the shaft of said second generator, whereby the shaft of said second generator is coupled to and rotatable with said rotatable driven rotor.

11. The system recited in claim 10, wherein said rotatable driven rotor includes an outer rim spaced from and extending around the coupling sleeve thereof and water impact surfaces connected to said outer rim, wherein the water exiting the water transmitting arms of said driving second turbine strikes the water impact surfaces connected to said outer rim to cause said rotatable driven rotor and the shaft of said second generator to rotate in said second direction.

12. The system recited in claim 9, further comprising a windproof casing surrounding each of the water-transmitting arms of said driving second turbine and said rotatable driven rotor.

13. The system recited in claim 12, further comprising a drain extending between said windproof casing and said source of water.

14. A system to generate electricity, comprising:
a source of water;
a first turbine communicating with said source of water;
a second turbine connected in fluid communication with said first turbine, said second turbine having a rotatable shaft and a set of hollow arms coupled to and rotatable with said shaft;
a rotatable driven rotor located in proximity to the hollow arms of said second turbine;
a first generator of the electricity having a rotatable shaft coupled to the shaft of said first turbine; and
a second generator of the electricity having a rotatable shaft coupled to said rotatable driven rotor,
said first turbine supplying water from said source of water through the hollow arms of said second turbine, said water exiting said hollow arms generating a first rotational force for causing said hollow arms, the rotatable shaft of said first turbine, and the rotatable shaft of said first generator to rotate, and the water exiting said hollow arms also imparting a second rotational force against said rotatable driven rotor for causing said driven rotor and the rotatable shaft of said second generator to rotate.

15. The system recited in claim 14, wherein said first turbine is submerged within said source of water.

16. The system recited in claim 15, wherein said submerged first turbine has a set of rotatable turbine blades, said first turbine receiving water from the source thereof, and said turbine blades rotating to cause said water to be supplied through the hollow arms of said second turbine.

17. The system recited in claim 16, further comprising a water input pipe and a water output pipe each communicating with said submerged first turbine, a pump connected to said water input pipe, and a reservoir in which water is stored, said reservoir located above said source of water and connected between the set of hollow arms of said second turbine and each of said pump and said water output pipe, said pump pumping water from said reservoir to said submerged first turbine by way of said water input pipe to cause said turbine blades to rotate, and said rotating turbine blades causing the water received from said source to be forced through the set of hollow arms of said second turbine by way of said water output pipe and said reservoir.
